(19) United States
(12) Patent Application Publication
(10) Pub. No.: US 2007/0198557 A1
(43) Pub. Date: Aug. 23, 2007

(54) Generic object database system and design

(75) Inventors: Aaron Kwong Yee Ching, Bellevue, WA (US); Robert William Moore, Bothell, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/360,191

(22) Filed: Feb. 23, 2006

(51) Int. Cl. G06F 7/00

(52) U.S. Cl. 707/101

(57) ABSTRACT

In an embodiment, a method of designing a schema to implement an object database system is provided. A first table type may be defined in the schema that may include a layout for an object table. The object table may define an instance of an object in the object data-base system. A second table may be defined in the schema that may include a layout of an object relations table. The object relations table may define a type of relation between instances of at least two objects in the object database system. Each of the instances of the at least two objects may be defined by a respective entry of the object table.

### TECHNICAL FIELD

The present invention relates to a design for a database system, and in particular to methods, systems, and machine-readable media for designing and using a generic object database system.

### BACKGROUND

Most data-driven applications use a relational database system to store information for multiple entities. Relational database systems store all data within tables, which include a set of rows and columns. Each row of the table is analogous to a record of a file and each column is analogous to a field of a record.

A relationship may be established between two tables in a relational database system by having one or more common columns in each of the two tables. Thus, rows from two tables may be joined by using the one or more common column values.

A database schema describes a structure of a database and defines data contents and relationships. Some relationships in a relational database system may be many-to-many relationships between two different types of entities. Many-to-many relationships permit one to relate each row in one table to many rows in another table, and vice versa. Such relationships are represented in a relational database system by defining a junction table, which is an intermediate table that is created to implement a many-to-many relationship between two entities. The intermediate table includes primary keys from the two entities as foreign keys.

If user requirements of a database system change, the database schema may require modifications. Such modifications may be difficult and time consuming, particularly if user requirements change frequently. For example, if a new entity (table) is to be added to a relational database system, the schema must be modified to define a new table. If the new entity has a many-to-many relationship with another entity, then a new junction table must be defined to implement the many-to-many relationship. If a new attribute is to be added to an entity, the schema must be modified to add a new column to the table corresponding to the entity. Further, in an n-tier system architecture, component code changes may also be required as a result of changes to the schema.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to designing a schema to implement an object database system. A first table type may be defined in the schema that may include a layout for an object table. The object table may define an instance of an object in the object database system. A second table may be defined in the schema that may include a layout of an object relations table. The object relations table may define a type of relation between instances of at least two objects in the object database system. Each of the instances of the at least two objects may be defined by a respective entry of the object table.

### DRAWINGS

In order to describe the manner in which the above-recited and other advantages and features can be obtained, a more particular description is described above and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings in which:

FIG. 1 illustrates an exemplary operating environment consistent with principles of the invention.

FIG. 2 is a block diagram that illustrates an exemplary processing device that may be used to implement embodiments

FIG. 3 is a diagram of an exemplary schema that may be used in implementations.

FIG. 4 is a diagram of a second exemplary schema that may be used in implementations.

FIG. 5 is a flowchart illustrating an exemplary process for building the exemplary schema of FIG. 3.

FIG. 6 is a flowchart illustrating an exemplary process for building the exemplary schema of FIG. 4.

FIG. 7A illustrates objects in an exemplary database and a relation between the objects.

FIG. 7B illustrates an exemplary change to the objects and relationships of the exemplary database of FIG. 7A.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the invention.

### Overview

Implementations consistent with the principles of the invention provide a database system that is flexible with respect to changes in user requirements. A generic database schema may be used to represent most common entity-relationship data requirements. The generic database schema may provide an ability to add or remove entities without a need to modify a physical database schema.

Implementations that use a generic database schema may fulfill data store requirements for most applications that include a typical entities-relationship model. Such implementations may accommodate any number of entities, or objects, each of which may have any number of attributes, or object properties. Further any number of one-to-many or many-to-many relationships, or object relations, may be generated between any of the entities. New objects, object relations and object properties may be created at run-time without altering the physical database schema.

### Exemplary Operating Environment

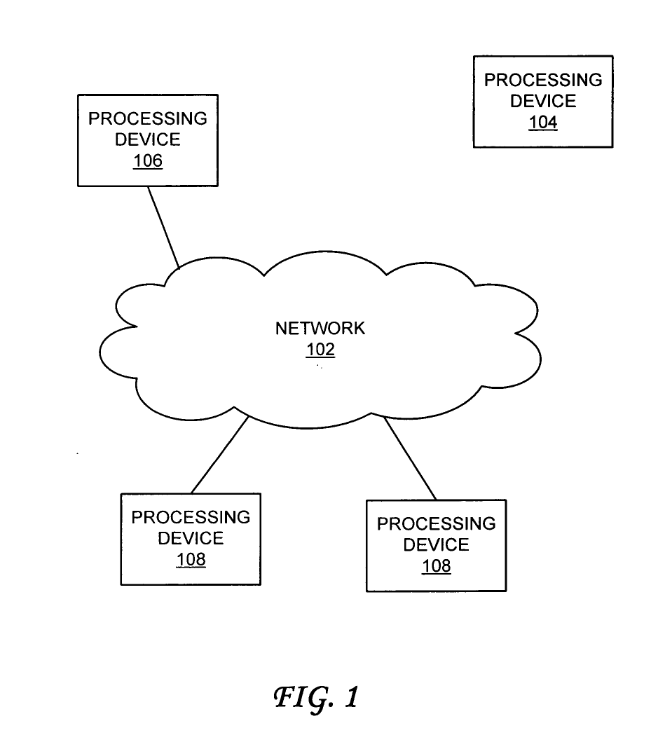

FIG. 1 illustrates an exemplary operating environment consistent with the principles of the invention. The operating environment may include a network 102, a first processing device 104, a second processing device 106 and a third processing device 108.

Network 102 may include a number of different types of networks, such as, for example, a packet-switching network, a wireless network, an ATM network, a Frame Relay network, an optical network, a Public Switched Telephone Network (PSTN), the Internet, or an intranet or other types of networks, or any combination of the above networks.

First processing device 104 may be a stand-alone processing system that includes a database system consistent with the principles of the invention. First processing device 104 may be used by a number of different users and applications that access the database system.

Second processing device 106 may be a processing device that includes a database system and may act as a server to client processing devices that may include applications for accessing the database system of second processing device 106 via network 102.

Third processing device 108 may be a processing system that may act as a client processing device and may include applications that access the database system of second processing device 106 via network 102.

### Exemplary Processing System

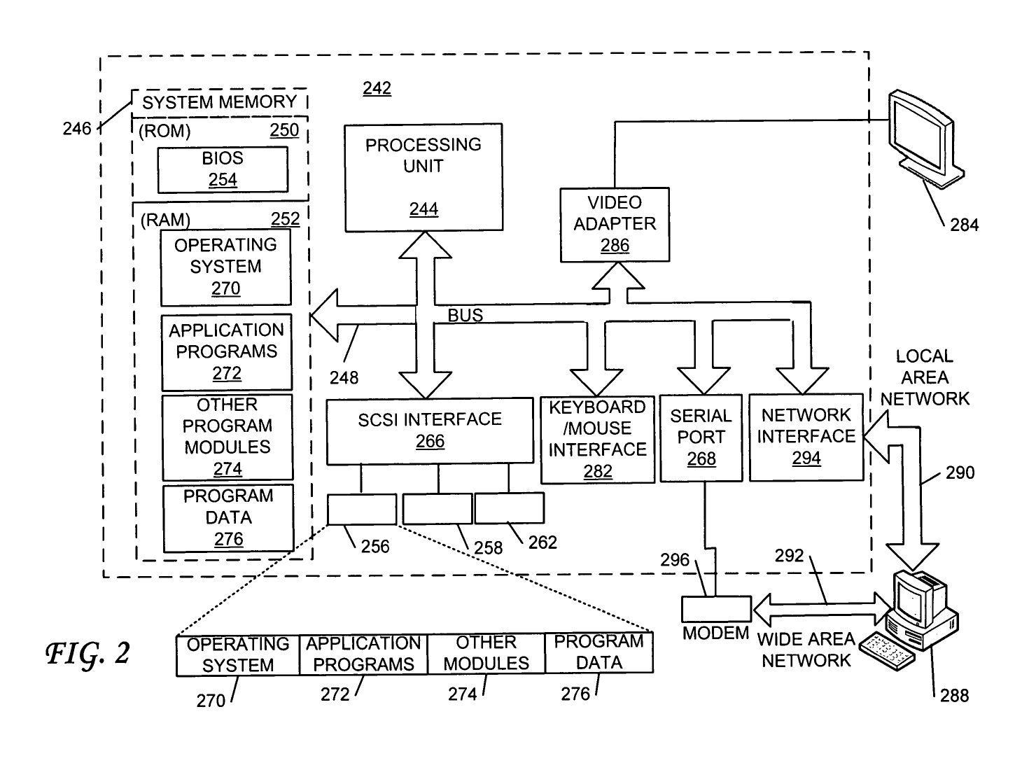

FIG. 2 shows an exemplary processing system 242 that may be used to implement first processing device 104, second processing device 106 or third processing device 108. System 242 may include one or more processors or processing units 244, a system memory 246, and a bus 248 that couples various system components, including system memory 246 to processing unit 244. Bus 248 may represent one or more of any of several types of bus structures, including a memory bus or memory controller, a peripheral bus, an accelerated graphics port, and a processor or local bus using any of a variety of bus architectures. System memory 246 may include read only memory (ROM) 250 and random access memory (RAM) 252. A basic input/output system (BIOS) 254 may be included in ROM 250 and may include basic routines that help transfer information between elements within system 242, such as during start-up.

System 242 may include a hard disk drive 256 for reading from and writing to a hard disk (not shown), a magnetic disk drive 258 for reading from and writing to a removable magnetic disk (not shown), and an optical disk drive 262 for reading from or writing to a removable optical disk (not shown) such as a CD ROM or other optical media. Hard disk drive 256, magnetic disk drive 258, and optical disk drive 262 may be connected to bus 248 by a Small Computer System Interface (SCSI) 266 or some other appropriate interface. The drives and their associated computer-readable media may provide nonvolatile storage of computer-readable instructions, data structures, program modules and other data for system 242. Although exemplary system 242 described herein may employ a hard disk, a removable magnetic disk and a removable optical disk, it should be appreciated by those skilled in the art that other types of machine-readable media which can store data that is accessible by a processing system, such as magnetic cassettes, flash memory cards, digital video disks, random access memories (RAMs), read only memories (ROMs), and the like, may also be used in an exemplary operating environment.

A number of program modules may be stored on the hard disk (not shown), magnetic disk (not shown), optical disk, ROM 250, RAM 252, or other media. The program modules may include an operating system 270, one or more application programs 272 (such as a database system), cache/other modules 274, and program data 276 (such as a database). A user may enter commands and information into system 242 through input devices such as, for example, a keyboard (not shown) and a pointing device (not shown). These and other in-put devices may be connected to processing unit 244 through an interface 282 that may be coupled to bus 248. A monitor 284 or other type of display device may be connected to bus 248 via an interface, such as, for example, a video adapter 286.

System 242 may implement a server, such as, for example, second processing device 106, or a client, such as third processing device 108. Second processing device 106 and third processing device 108 may operate in a networked environment using logical connections to one or more remote processing devices, such as a remote processing device 288. Remote processing device 288 may be a server processing device or a client processing device and may typically include many or all of the elements described above relative to system 242. The logical connections depicted in FIG. 2 may include a local area network (LAN) 290 and a wide area network (WAN) 292. Such networking environments are commonplace in offices, enterprise-wide computer networks, intranets, and the Internet.

When used in a LAN networking environment, system 242 may be connected to the local network through a network interface or adapter 294. When used in a WAN networking environment, system 542 may include a modem 296 or other means for establishing communications over wide area network 292, such as the Internet. Modem 296, which may be internal or external, may be connected to bus 248 via a serial port interface 268. In a networked environment, program modules depicted relative to system 242, or portions thereof, may be stored in a remote memory storage device. It will be appreciated that the network connections shown are exemplary and other means of establishing a communications link between the computers may be used.

When system 242 is used to implement first processing device 104 as a stand alone processing device, system 242 may not include networking hardware and/or software. For example, system 242 may not include network interface 294 and may not interface to modem 296.

One or more processing units 244 of system 242 may be programmed by instructions stored at different times in various computer-readable storage media. Programs and operating systems may be distributed, for example, on floppy disks, CD-ROMs, or via a network, such as network 102. The programs or operating systems may be installed or loaded into a secondary memory of a processing system. At execution, they are loaded at least partially into the computer's primary memory. Aspects of embodiments of the invention, described herein, include these and other various types of machine-readable storage media.

For purposes of illustration, programs and other executable program components, such as the operating system, are illustrated herein as discrete blocks, although it is recognized that such programs and components may reside at various times in different storage components of the processing system, and may be executed by the data processor(s) of the processing system.

Various modules and techniques may be described herein in the general context of computer-executable instructions, such as program modules, executed by one or more processing devices. Generally, program modules include routines, programs, objects, components, data structures, etc. that perform particular tasks or implement particular abstract data types. Typically, the functionality of the program modules may be combined or distributed as desired in various embodiments.

### Exemplary Schemas

The following illustrates two exemplary schemas that may be used in embodiments. The exemplary schemas each illustrate an exemplary layout for a number of tables of a database, such as, for example, a relational database. The schemas may include definitions for a number of tables, including tables for defining objects, object types, properties of object types, properties of objects, object relations and relation types.

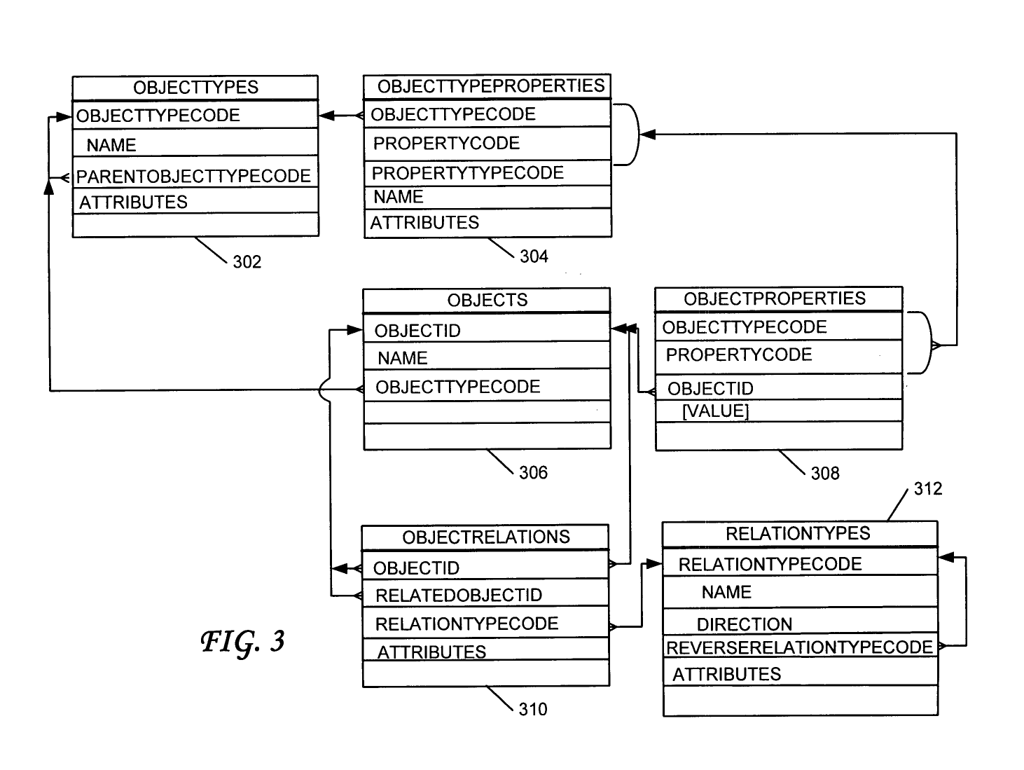

FIG. 3 illustrates an exemplary schema that may be employed in implementations consistent with the principles of the invention. The schema may be a schema for a relational database system and may treat entities as data objects. The schema may include definitions of several tables, including ObjectTypes 302, ObjectTypeProperties 304, Objects 306, ObjectProperties 308, ObjectRelations 3 10 and RelationTypes 312. Each table, as shown in FIG. 3, illustrates a layout of an entry of the particular table.

ObjectTypes 302 may be a table that defines types of objects that may be included in the database system. ObjectTypes 302 may include ObjectTypeCode, Name, ParentObjectTypeCode and one or more attributes. ObjectTypeCode may be a primary key used to uniquely identify an entry in table ObjectTypes 302. Name may be a name of an object type. ParentObjectTypeCode may be a foreign key to ObjectTypeCode, which may indicate an ObjectTypeCode for an object type that may be a parent to the current object type in a hierarchical structure or relationship. A foreign key is a key that may be used to point to and access an entry in a table that is uniquely identified by the foreign key and uses the foreign key as a primary key. Attributes may be one or more fields that may store additional information about the object type. The additional information may be defined in a markup language, such as, for example, eXtensible Markup Language (XML).

Table ObjectTypeProperties 304 may be a table that defines properties of an object type. Table ObjectTypeProperties 304 may include ObjectTypeCode, PropertyCode, PropertyTypeCode, Name and one or more attributes. ObjectTypeCode may be a foreign key to ObjectTypeCode in table ObjectTypes 302. Thus, ObjectTypeCode of ObjectTypeProperties 304 may be used to point to and access a particular entry of table ObjectTypes 302. PropertyCode may be a value that may be combined with ObjectTypeCode to form a composite key that may be used as a primary key to uniquely identify an entry in ObjectTypeProperties 304. PropertyTypeCode may specify a property data type, such as for example, a name field, an address field, or user interface data types, such as, for example, textbox, richtextbox, choice, dropdownlist, etc. Name may be a name of a property. Attributes may be one or more fields that may store additional information about the property. The additional information may be defined in a markup language, such as, for example, eXtensible Markup Language (XML).

Table Objects 306 may be a table that defines instances of objects. Table Objects 306 may include ObjectID, Name and ObjectTypeCode. ObjectID may be a unique value and may be a primary key to uniquely identify an instance of an object. Name may be a name of an instance of an object. ObjectTypeCode may be a foreign key that may be used to point to and access an unique entry in table ObjectTypes 302.

Table ObjectProperties 308 may be a table that defines properties of instances of objects. Table ObjectProperties 308 may include ObjectTypeCode, PropertyCode, ObjectID and a value, which may be the value of the particular property. ObjectTypeCode and Propertycode may be combined to form a composite key, which may be used to point to and access an entry in table ObjectTypeProperties 304 that may be uniquely identified by the composite key. ObjectID may be a foreign key that may be used to point to and access an entry in Table Objects 306 that may be uniquely identified by ObjectID.

Table ObjectRelations 310 may be a table that defines relation types between two objects. Table ObjectRelations 310 may include ObjectID, RelatedObjectID, RelationTypeCode and one or more attributes. ObjectID may be a foreign key that may be used to point to and access a unique entry in Table Objects 306. RelatedObjectID may be a foreign key to point to and access another unique entry in Table Objects 306, which may correspond to a second object of a relation defined by the entry of table ObjectRelations 310. RelationTypeCode may define a type of relation between two objects and may be a foreign key that may be used to point to and access a unique entry in table RelationTypes 312. Attributes may be one or more fields that may store additional information about a relation, such as, for example, a strength of a relation or other information. The additional information may be defined in a markup language, such as, for example, extensible Markup Language (XML).

Table RelationTypes 312 may be a table that defines relations between two objects. Table RelationTypes 312 may include RelationTypeCode, Name, Direction, ReverseRelationTypeCode and one or more attributes. RelationTypeCode may be a primary key used to uniquely identify an entry in table RelationTypes 312. Name may be a name of a relation. Direction may be a value that indicates a hierarchical direction of a relation type. In one implementation, integer values may be used, although other values may be used in other implementations. In one implementation that uses integer values, a 0 value may indicate a relation that is equally bi-directional between two objects, a I value may indicate that an object indicated by ObjectID is at a higher level than an object indicated by RelatedObjectID and a 2 value may indicate that the object indicated by ObjectID is at a lower level that the object indicated by RelatedObjectID. Other values may be used in other implementations consistent with the principles of the invention. ReverseRelationTypeCode may be a foreign key that may be used to point to and access a unique entry of table RelationTypes 312 that may define an opposite or reverse relation between the two objects. Attributes may be one or more fields that may store additional information about a relation, such as, for example, “is part of”, “works for”, “is a member of” or other information. The additional information may be defined in a markup language, such as, for example, extensible Markup Language (XML).

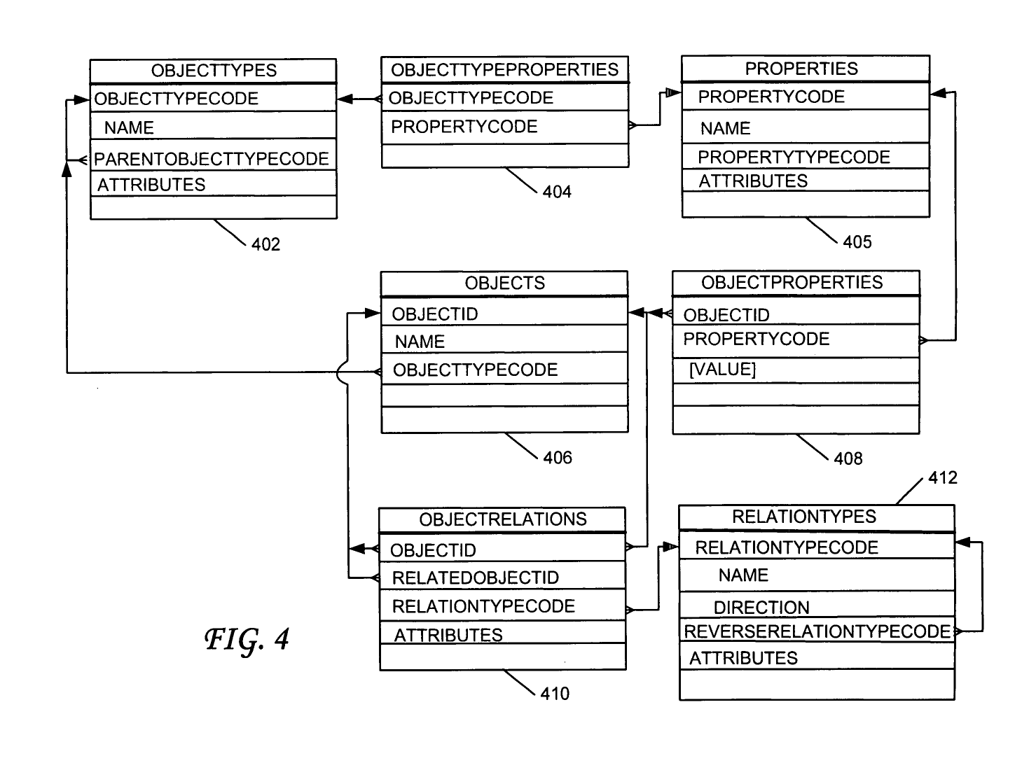

FIG. 4 illustrates another exemplary schema that may be employed in implementations consistent with the principles of the invention. The schema may be a schema for a relational database system and may treat entities as data objects. The schema may include definitions of several tables, including ObjectTypes 402, ObjectProperties 404, Properties 405, Objects 406, ObjectProperties 408, ObjectRelations 410 and RelationTypes 412. Each table, as shown in FIG. 4, illustrates a layout of an entry of the particular table.

Table ObjectTypes 402 may be a table that defines types of objects that may be included in the database system. Table ObjectTypes 402 may include ObjectTypeCode, Name, ParentObjectTypeCode and one or more attributes. ObjectTypeCode may be a primary key used to uniquely identify an entry in table ObjectTypes 402. Name may be a name of an object type. ParentObjectTypeCode may be a foreign key that may be used to point to and access a unique entry of table ObjectTypes 402 that may be a parent to the current object type in a hierarchical structure. Attributes may be one or more fields that may store additional information about the object type. The additional information may be defined in a markup language, such as, for example, extensible Markup Language (XML).

Table ObjectTypeProperties 404 may be a table that defines default properties of an object type. ObjectTypeProperties 404 may include ObjectTypeCode and PropertyCode. ObjectTypeCode may be a foreign key to point to and access a unique entry in table ObjectTypes 402. PropertyCode may be a foreign key to point to and access a unique entry in table Properties 405.

Table Properties 405 may be a table that defines properties of objects. Table Properties 405 may include PropertyCode, Name, PropertyTypeCode and one or more attributes. PropertyCode may be a primary key used to uniquely identify an entry of table Properties 405. Name may be a name of a property. PropertyTypeCode may specify a property data type, such as for example, a name field, an address field, or user interface data types, such as, for example, textbox, richtextbox, choice, dropdownlist, etc. Attributes may be one or more fields that may store additional information about the property. The additional information may be defined in a markup language, such as, for example, eXtensible Markup Language (XML).

Table Objects 406 may be a table that defines instances of objects. Table Objects 406 may include ObjectID, Name and ObjectTypeCode. ObjectID may be a unique value and may be a primary key that uniquely identifies an instance of an object. Name may be a name of an instance of an object. ObjectTypeCode may be a foreign key that may be used to point to and access a unique entry in table ObjectTypes 402.

Table ObjectProperties 408 may be a table that defines properties of instances of objects. Table ObjectProperties 308 may include, ObjectID, PropertyCode and a value. Object-ID may be a foreign key that may be used to point to and access a unique entry in table Objects 406. PropertyCode may be a foreign key that may be used to point to and access a unique entry of table Properties 405. Value may indicate the value of the particular property for an instance of an object.

Table ObjectRelations 410 may be a table that defines relation types between two objects. Table ObjectRelations 3 10 may include ObjectID, RelatedObjectID, RelationTypeCode and one or more attributes. Object]D may be a foreign key that may be used to point to and access a unique entry in table Objects 406. RelatedObjectID may be a foreign key to point to and access another unique entry in table Objects 406, which may correspond to a second object of a relation. RelationTypeCode may define a type of relation between two objects and may be a foreign key that may be used to point to and access a unique entry in table RelationTypes 412. Attributes may be one or more fields that may store additional information about a relation, such as, for example, a strength of a relation or other information. The additional information may be defined in a markup language, such as, for example, eXtensible Markup Language (XML).

Table RelationTypes 412 may be a table that defines relations between two objects. RelationTypes 412 may include RelationTypeCode, Name, Direction, ReverseRelationTypeCode and one or more attributes. RelationTypeCode may be a primary code used to uniquely identify an entry in Table RelationTypes 412. Name may be a name of a relation. Direction may be a value that indicates a hierarchical direction of a relation type. In one implementation, integer values may be used, although other values may be used in other implementations. In one implementation that uses integer values, a 0 value may indicate a relation that is equally bi-directional between two objects, a 1 value may indicate that an object indicated by ObjectID is at a higher level than an object indicated by RelatedObjectID and a 2 value may indicate that the object indicated by ObjectID is at a lower level that the object indicated by RelatedObjectID. Other values may be used in other implementations consistent with the principles of the invention. ReverseRelationTypeCode may be a foreign key that may be used to point to and access a unique entry of table RelationTypes 412 that may define an opposite or reverse relation between the two objects. Attributes may be one or more fields that may store additional information about a relation, such as, for example, “is part of”, “works for”, “is a member of” or other information. The additional information may be defined in a markup language, such as, for example, eXtensible Markup Language (XML).

The schemas illustrated in FIGS. 3 and 4 are only exemplary and may include other or different information or tables than as described above. For example, other information, such as a sort order, may be included in some table entries, such as entries for tables ObjectTypes 302, 402, ObjectTypeProperties 304, 404, ObjectRelations 310, 410 and ObjectProperties 408. Other information such as, for example, date of creation, or modification date may also be included in table entries such as, for example, Objects 306, 406, ObjectProperties 308, 408 and ObjectRelations 310, 410. Further, various attributes may be included, such as, for example, strength of a relation in table ObjectRelations 310, 410.

### Exemplary Processes of Designing a Schema

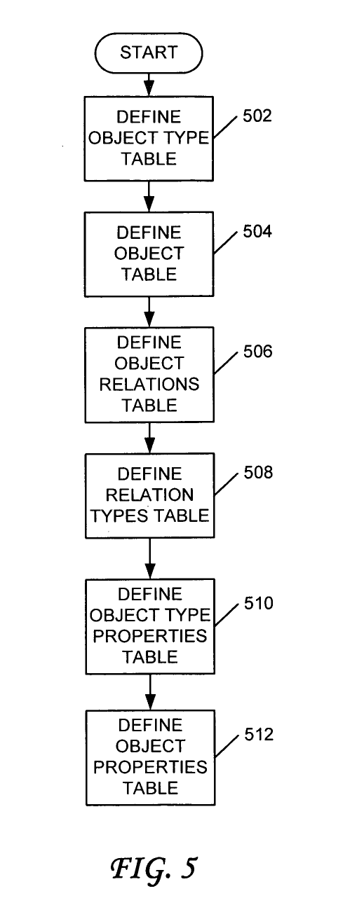

FIG. 5 is a flowchart that illustrates an exemplary process for designing a schema consistent with the principles of the invention, such as the schema shown in FIG. 3. The process may begin with defining a layout of table ObjectTypes 302 (act 502), which may be used to define all available object types. Next, a layout of table Object 306 may be defined (act 504), which may store instances of objects. A layout of table ObjectRelations 310 may then be defined (act 506), which may be used to define relations between two objects. A layout of table RelationType 312 may then be defined, which may be used to define relation types and reverse relation types (act 508). A layout of table ObjectTypeProperties 304 may then be defined (act 510), which may be used to define properties associated with an object type. A layout of table ObjectProperties 308 may then be defined, which may be used to store a property value for an instance of an object (act 512).

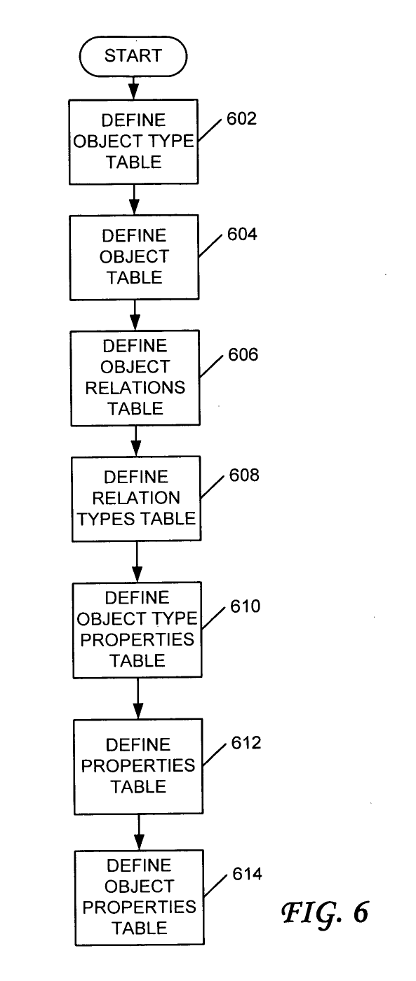

FIG. 6 is a flowchart that illustrates another exemplary process for designing a schema consistent with the principles of the invention, such as the schema shown in FIG. 4. The process may begin with defining a layout of table ObjectType 402 (act 602), which may be used to define all available object types. Next, a layout of table Object 406 may be defined (act 604), which may be used to store instances of objects. A layout of table ObjectRelations 410 may then be defined (act 606), which may be used to define relations between two objects. A layout of table RelationType 412 may then be defined (act 608), which may be used to define relation types and reverse relation types. A layout of table ObjectTypeProperties 404 may then be defined (act 610), which may be used to define properties associated with an object type. A layout of table Properties 405 may be defined (act 612), which may be used to define properties of objects. A layout of table ObjectProperties 408 may then be defined (act 614), which may be used to store an actual property value for an instance of an object (act 614).

### Flexibility Examples

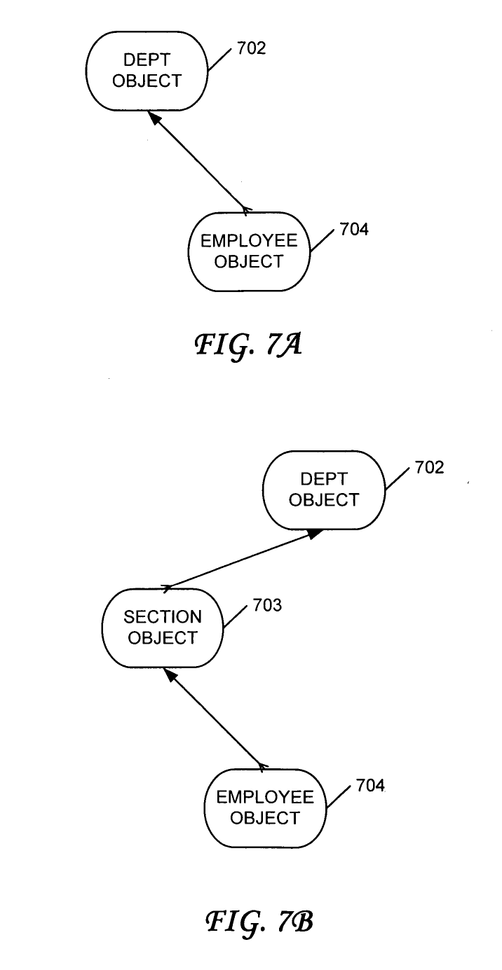

FIG. 7A illustrates an example of two objects in an implementation of a database consistent with the principles of the invention, DeptObject 702 and EmployeeObject 704. With respect to the exemplary schema of FIG. 3, an instance of DeptObj 702 may exist in the database as an entry of table Objects 306. That is, a unique primary key, ObjectID, may have a unique value such as, for example, “OBJ123”, a name such as, for example, “DeptObj”, and a foreign key, ObjectTypeCode, such as, for example, “Dept905”, for accessing an associated entry of table ObjectTypes 302 may exist as an entry in table Objects 306. Similarly, an instance of EmployeeObject 704 may exist in the database as a second entry of table Objects 306. That is, a unique primary key, ObjectID, may have a value such as, for example, “OBJ124”, a name such as, for example, “EmplObj”, and a foreign key, ObjectTypeCode, which may have a value such as, for example, “Empl167”, for accessing an associated entry of table ObjectTypes 302, may exist as the second entry in table Objects 306.

Table ObjectTypes 302 may define a corresponding object type for each object instance. Some object instances may have the same object type. In the example of FIG. 7A, the two objects have different object types. Thus, an entry of table ObjectTypes 302 associated with DeptObject 702 may have a unique primary key value of “Dept905” for ObjectTypeCode, may have a value for an object type name, such as for example, “DepartmentType”, may have a value for ParentObjectTypeCode, which, in this example, may be null if no parent object exists, and may have one or more attributes further describing the object type. Similarly, table ObjectTypes 302 may have another entry associated with EmployeeObject 704 and may have a unique primary key value of “Empl167” for ObjectTypeCode, may have a value for an object type name, such as for example, “EmployeeType”, may have a value for ParentObjectTypeCode, such as, for example, “Dept905”, and may have one or more attributes further describing the object type.

Table ObjectTypeProperties 304 may have an entry associated with the above two object types to define properties associated with each of the object types. For example, an entry of table ObjectTypeProperties 304 associated with DeptObject 702 may have a value of ObjectTypeCode of“Dept905”, which may be a foreign key for accessing an associated entry of ObjectTypes 302, a value of PropertyCode of, for example, “D8765”, a value of PropertyTypeCode of, for example, “DType666”, a value of Name of “Department Name”, and a value of one or more attributes that may further describe the property. Similarly, an entry of table ObjectTypeProperties 304 associated with EmployeeObject 704 may have a value of ObjectTypeCode of “Empl167”, which may be a foreign key for accessing an associated entry of table ObjectTypes 302, a value of PropertyCode of, for example, “E8744”, a value of PropertyTypeCode of, for example, “Etype744”, a value of Name of, for example, “EmployeeIDNum”, and a value of one or more attributes that may further describe the property.

Table ObjectProperties 308 may have an entry associated with each of the above two objects. An entry of table ObjectProperties 304 associated with DeptObject 702 may have a value for ObjectTypeCode of “Dept905” and a value for PropertyCode of “D8765”, which may be used as a composite foreign key for accessing an associated entry of table ObjectTypeProperties 304, a value for ObjectID of “OBJ123”, which may be a foreign key to an associated entry of table Objects 306, and a value of the property corresponding to an instance of DeptObject 702, such as, for example, “Advanced Projects”. Similarly, an entry of table ObjectProperties 308 associated with EmployeeObject 704 may have a value for ObjectTypeCode of “Empl167” and a value for PropertyCode of “Etype744”, which may be used as a composite foreign key for accessing an associated entry of table ObjectTypeProperties 304, a value for ObjectID of “OBJ124”, which may be a foreign key to an associated entry of table Objects 306, and a value of the property corresponding to an instance of EmployeeObject 704, such as, for example, “00198”.

Table ObjectRelations 310 may have an entry associated each of the above two objects. An entry of ObjectRelations 310 associated with DeptObject 702 may have a value for ObjectID of “OBJ123”, which may be a foreign key to an associated entry of table Objects 306. RelatedObjectID may have a value of “OBJ124”, which may indicate a relationship with EmployeeObject 704, which may be a foreign key to the entry of table Objects 306 corresponding to an instance of EmployeeObject 704. RelationTypeCode may be a foreign key to access an associated entry of table RelationTypes 312, which may include information that further describes the relationship. Similarly, an entry of table ObjectRelations 310 associated with EmployeeObject 704 may have a value for ObjectID of“OBJ124”, which may be a foreign key to an associated entry of table Objects 306. RelatedObjectID may have a value of“OBJ123”, which indicates a relationship with DeptObject 702, which may be a foreign key to the entry of table Objects 306 corresponding to an instance of DeptObject 702. RelationTypeCode may be a foreign key to an associated entry of table RelationTypes 312, which may include information that further describes the relationship.

Table RelationTypes 312 may have entries associated with a relationship between the above-mentioned two objects. An entry of RelationTypes 312 that describes a relation between DeptObject 702 and EmployeeObject 704 may have a unique value for RelationTypeCode, for example, “DM993” which may be a primary key for the entry of RelationTypes 312. Name may have a value of, for example, “DepartmentMembers” as a name of the relationship. Direction may have a value of, for example, 1, indicating that DeptObject 702 is of a higher level than EmployeeObject 704. ReverseRelationTypeCode may be a foreign key to access a unique entry of table RelationTypes 312 associated with a reverse relationship and may have a value such as, for example, “WO8765”. Attributes may include other information about the relationship. Similarly, an entry of table RelationTypes 312 that describes a relation between EmployeeObject 704 and DeptObject 702 may have a unique value for RelationTypeCode, for example, “WO8765” which may be a primary key for the entry of table RelationTypes 312. Name may have a value of, for example, “EmployeesInDept” as a name of the relationship. Direction may have a value of, for example, 2, indicating that EmployeeObject 704 is of a lower level than DeptObject 702. ReverseRelationTypeCode may be a foreign key to an entry of table RelationTypes 312 associated with a reverse relationship and may have a value such as, for example, “DM993”. Attributes may include other information about the relationship.

FIG. 7B illustrates a new object, SectionObject 703, added to the exemplary database, and a change in relationships. For example, DeptObjects 702 and SectionObject 703 have a relationship and SectionObject 703 and EmployeeObject 704 have a relationship. To add new object SectionObject 703 to the database, a new entry for table Objects 306 may be created to represent an instance of SectionObject 703. If SectionObject 703 is a type of object that already exists, then ObjectTypeCode of the new entry of table Objects 306 may be a foreign key for accessing the associated existing entry of table ObjectTypes 302. If Section-Object 703 is a new type of object, then ObjectTypeCode of the entry of table Objects 316 may be a foreign key to a new entry of table ObjectTypes 302.

Table ObjectTypeProperties 304 may have an entry corresponding to the new object type, if SectionObject 703 is a new type of object. Otherwise, an existing entry of table ObjectTypeProperties 304 may be associated with SectionObject 703.

Table ObjectProperties 308 may have an entry associated with SectionObject 703. The entry of table ObjectProperties 308 may have an ObjectTypeCode and a PropertyCode that may be a composite foreign key to an associated entry of table ObjectTypeProperties 304. ObjectID may be a foreign key to an entry of table Objects 306 corresponding to the instance of SectionObject 703. Value may be a value of the property corresponding to the instance of SectionObject 703.

Object Relations 310 and RelationTypes 312 may have entries corresponding to a relation between instances of objects DeptObject 702 and SectionObject 703, SectionObject 703 and DeptObject 702, SectionObject 703 and EmployeeObject 704, and EmployeeObject 704 and SectionObject 703.

Thus, the above exemplary database change illustrates that such a change may be made without any changes to the schema.

The schema of FIG. 4 also has the flexibility to permit a change, such as that shown by FIGS. 7A and 7B without any changes to the schema. The schema of FIG. 4 is very similar to the schema of FIG. 3. The schema of FIG. 4 differs from that of FIG. 3, in that the schema of FIG. 4 has a new table, Properties 405, which may define the properties of an object, table ObjectTypeProperties 404 includes ObjectTypeCode, which may be a foreign key to an associated entry of table ObjectTypes 402, and includes PropertyCode, which may be a foreign key to an associated entry of table Properties 405, and table ObjectProperties 408 may include PropertyCode, which may be a foreign key to an associated entry of table Properties 405. The addition of new object SectionObject 703 may result in creation of another entry of table Objects 406, may result in new entries of Tables ObjectTypes 402 and ObjectProperties 404, if SectionObject is of a new object type, and may result in a new entry of table properties 405, if SectionObject 703 has one or more properties not previously defined for an object. A new entry of table ObjectProperties 408 may include a value of a property for an instance of SectionObject 703.

### CONCLUSION

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, network PCs, minicomputers, mainframe computers, and the like. Embodiments may also be practiced in distributed computing environments where tasks are performed by local and remote processing devices that are linked (either by hardwired links, wireless links, or by a combination thereof through a communications network. In a distributed computing environment, program modules may be located in both local and remote memory storage devices.

Although the above description may contain specific details, they should not be construed as limiting the claims in any way. Other configurations of the described embodiments of the invention are part of the scope of this invention. For example, hardwired logic may be used in implementations instead of processors, or one or more application specific integrated circuits (ASICs) may be used in implementations consistent with the principles of the invention. Further, implementations consistent with the principles of the invention may have more or fewer acts than as described, or may implement acts in a different order than as shown. Accordingly, the appended claims and their legal equivalents should only define the invention, rather than any specific examples given.

We claim as our invention:

1. A method of designing a schema to implement an object database system, the method comprising:
defining in the schema a first table type that includes a layout for an object table, the object table being for defining an instance of an object in the object database system (306, 406, 504, 604); and
defining in the schema a second table type that includes a layout for an object relations table, the object relations table being for defining a type of relation between instances of at least two objects in the object database system (310, 410, 506, 606), wherein:
each of the instances of the at least two objects is defined by a respective entry of the object table.

2. The method of claim 1, wherein the layout for the object relations table includes one or more attributes of a type of relation.

3. The method of claim 2, further comprising:
defining a third table type that includes a layout of a relation type table for defining a relation type in the database management system, wherein:
the layout for the object relations table includes a field for a key to point to an entry of the relation type table.

4. The method of claim 1, further comprising:
defining a third table type that includes a layout for an object type table for defining an object type in the database management system, wherein
the layout for the object table defines a key field for pointing to an instance of an object.

5. The method of claim 4, wherein the layout of the object type table type defines a field for indicating a parent object type.

6. The method of claim 4, further comprising:
defining a fourth table type that includes a layout for an object type property table for defining a property associated with one or more object types, wherein
the layout for the object type property table defines a key field to point to an entry of the object type table.

7. A processing system (244) arranged to access a database system (272, 276), the processing system comprising:
a memory (246); and
a processor operatively connected to the memory (244), wherein:
the processor is arranged to access a database (276) of the database system (272, 276), the database comprising:
at least two entries of an object table (306, 406), each of the at least two entries of the object table including information about a respective object and representing a respective instance of the respective object,
an entry of an object relations table (310, 410) that defines a type of relation between the at least two instances of objects, the entry of the object relations table further including a first key for use in accessing one of the at least two entries of the object table and a second key for use in accessing another of the at least two entries of the object table,
an entry of a relation types table (312, 412) that further defines the type of relation, the entry of the relation types table further including hierarchical information with respect to the type of relation, wherein
the entry of the object relation table (310, 410) includes a key for use in accessing the entry of the relation types table.

8. The processing system of claim 7, wherein the entry of the object relation table includes a strength attribute for defining a strength of the type of relation between the at least two instances of objects.

9. The processing system of claim 7, wherein the entry of the object relations table that defines the type of relation between the at least two instances of the objects is the key for use in accessing the entry of the relation type table.

10. The processing system of claim 9, wherein the entry of the relation type table includes a reverse relation type.

11. The processing system of claim 7, wherein the database further comprises:
at least one entry of an object type table, each of the at least one entry of the object type table defining a respective object type, wherein
each of the at least two entries of the object table include an indication of an object type corresponding to one of the at least one entry of the object type table.

12. The processing system of claim 11, wherein the indication of the object type included in each of the at least two entries of the object table is a key for use in accessing a corresponding entry of the at least one entry of the object type table.

13. The processing system of claim 11, wherein the database further comprises:
at least one entry of an object type properties table including a key for use in accessing one of that at least one entry of the object type table.

14. The processing system of claim 13, wherein the database further comprises:
at least one entry of a properties table including information describing a property of an object, and
each of the at least one entry of the object type properties table including a key for use in accessing one of the at least one entry of the properties table.

15. A machine-readable medium (246) having recorded thereon a plurality of instructions for at least one processor, the machine-readable medium comprising:
instructions for accessing an entry of a first table (306, 406), the entry of the first table defining an instance of an object;
instructions for accessing an entry of a second table (302, 402), the entry of the second table defining an object type associated with the instance of the object, the entry of the first table including a foreign key for use in accessing the entry of the second table;
instructions for accessing an entry of a third table (308, 408), the entry of the third table defining a property of the instance of the object and a value associated with the property of the instance of the object;
instructions for accessing an entry of a fourth table (304, 405), the entry of the fourth table including data that further defines the property of the instance of the object, the entry of the third table including a foreign key for use in accessing the entry of the fourth table;
instructions for accessing an entry of a fifth table (310, 410), the entry of the fifth table defining a relation between the instance of the object, defined in the entry of the first table, and an instance of a second object, defined in a second entry of the first table, the entry of the fifth table further including a first foreign key for use in accessing the entry of the first table and a second foreign key for use in accessing the second entry of the first table; and
instructions for accessing an entry of a sixth table (312, 412), the entry of the sixth table defining a relation type between the instance of the object and the instance of the second object, the entry of the fifth table including a foreign key for use in accessing the entry of the sixth table.

16. The machine-readable medium of claim 15, further comprising:
instructions for accessing the entry of the fifth table to obtain information with respect to the instance of the first object and the instance of the second object.

17. The machine-readable medium of claim 15, wherein the foreign key included in the entry of the fifth table for use in accessing the entry of the sixth table is a relation type code, which is a primary key of the entry of the sixth table.

18. The machine-readable medium of claim 15, wherein the entry of the fifth table further includes at least one attribute which further describes relation information with respect to the instance of the object and the instance of the second object.

19. The machine-readable medium of claim 15, further comprising:
instructions for defining a new relation between two instances of objects respectively corresponding to two entries of the first table.

20. The machine-readable medium of claim 19, wherein the instructions for defining a new relation between two instances of objects further comprise:
instructions for creating a new entry of the fifth table, the new entry of the fifth table including a foreign key for use in accessing one of the two entries of the first table, a foreign key for accessing another of the two entries of the first table, and a foreign key for use in accessing an entry of the sixth table for defining a relation type between the two instances of objects.
